(19) United States
(12) Patent Application Publication
(10) Pub. No.: US 2019/0017668 A1
(43) Pub. Date: Jan. 17, 2019

(54) Recreational Solar Light

(71) Applicant: Matthew Brian Heaton, Six Mile, SC (US)

(72) Inventor: Matthew Brian Heaton, Six Mile, SC (US)

(21) Appl. No.: 15/648,754

(22) Filed: Jul. 13, 2017

(51) Int. Cl. F21S 9/03; F21S 4/10; H02S 40/38; F21V 23/04

(52) U.S. Cl. CPC F21S 9/037; F21V 23/0464; H02S 40/38; F21S 4/10

(57) ABSTRACT

This invention is technologically different, in that it provides a light weight, ergonomic, and has sustainable solar powered charging capabilities. This invention offers several advantages. Using the device as a fishing light, would eliminate the need for, large batteries, and battery cables. Batteries are expensive and heavy. Cables limit distance from bank or boat. This device can be used for swimming pool water, disinfecting purposes, by means of U-V light. Could also be used for night time recreational purposes. Also could be used in emergency situations.

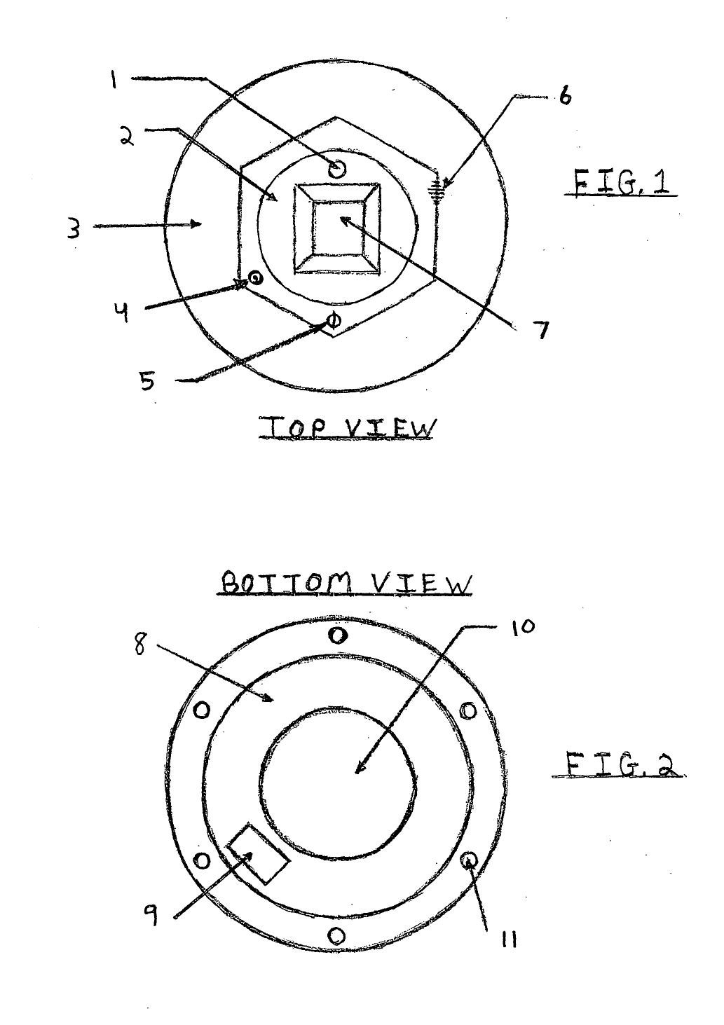

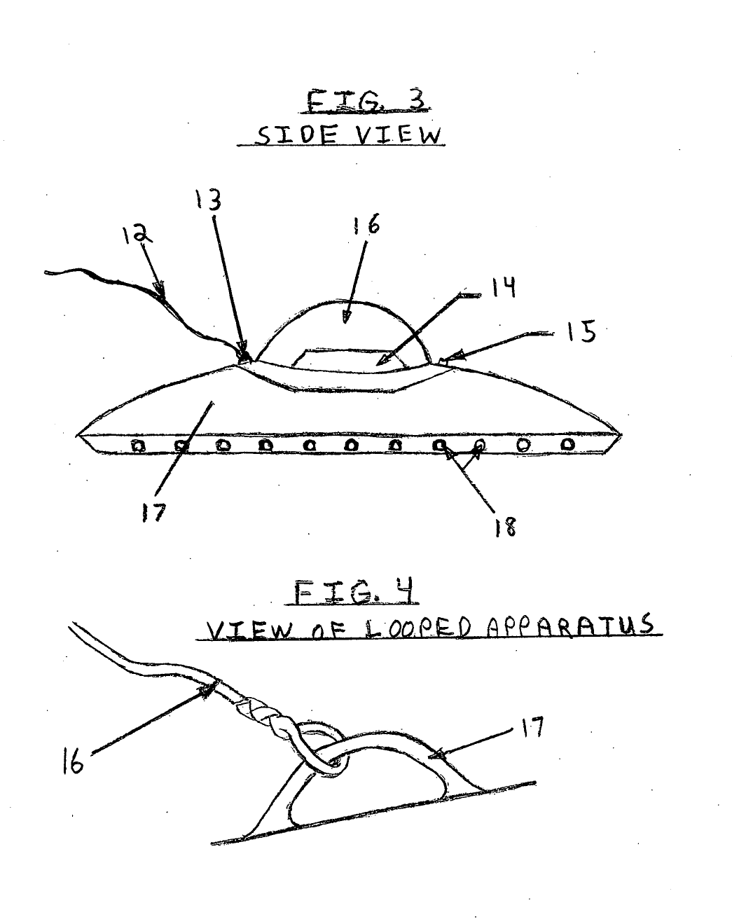

A solar powered light. Solar panel charges batteries by sunlight. Could have an optional AC/DC, power charging port. Device has a manual ON/OFF switch. An optional dusk to dawn sensor, could be added to turn device on at night and off during the day. Shall have a looped apparatus fastened, attached, or molded to device (see FIG. 4). String or cordage is then tied to looped apparatus, for securing device to bank, shore, or boat. Device could have an optional transparent globe, installed over solar panel, to protect from damage. Lights could be installed around the outside perimeter of buoyant body or casing. When device is turned on and placed into water, spot light will shine down into the water, so as to enhance night swimming and fishing applications.

### PROCESS OF MAKING

Recreational solar light body or casing built of buoyant material, as to cause device to float. Such as Coated Styrofoam, cellulose, cork, or equal. Entire device should be made of waterproof materials. Device should be fresh and salt water applicable. Manual ON/OFF switch is required, for fishing light model. Swimming pool and U-V light models should have the dusk till dawn to dawn ON/Off sensor. Sensor automatically turns on device at night and turns off device during the day. A looped apparatus will allow securing of rope, string, or cordage to device. For releasing device into water, and retrieving device back to bank, shore, or boat. Rechargeable batteries and lamp bulbs should be replaceable. Lighting lamps should be of LED type. Device could have, light color changing capabilities. Swimming pool models, which have a U-V light, with water disinfecting qualities. Should have U.V.C. type bulbs installed into device. This model could help disinfect water in swimming pools, fountains, small ponds, etc.

### MANNER OF USING

Shall be used for fishing, swimming, and water disinfecting purposes. A string or cordage of preferable length, shall be tied to looped apparatus, for securing device to bank, shore, or boat. Then device is turned on and placed into water, with spot light facing down into water. Device built for night time swimming, and fishing applications. When finished, device is simply pulled back to bank, shore, or boat using string or cordage. Device is then turned off and placed in a sunny location recharging batteries.

1. The claimed invention is, a solar powered recreational light. Device used for night fishing, and night swimming applications. Models of recreational solar light designed for swimming applications, shall have U-V light projection, for water disinfecting purposes.
Entire assembly comprising of;
a. Floating body or casing, made of buoyant material.
a. Solar panel.
a. Lighted lamps and/or bulbs.
a. Rechargeable battery or batteries.
a. ON/OFF switch.
a. Looped apparatus, fastened, attached, and/or molded to device. Will allow securing of rope, string, or cordage to device to bank, shore, or boat.
a. Transparent globe, for protecting solar panel (optional).
a. A dusk to dawn sensor, cuts device on at night and off during the day.
